(19) United States
(12) Patent Application Publication
(10) Pub. No.: US 2010/0250972 A1
(43) Pub. Date: Sep. 30, 2010

(54) REVERSIBLE POWER TRANSITIONS IN A COMPUTING DEVICE

(75) Inventor: Carlos Freitas, London (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: NOKIA CORPORATION

(21) Appl. No.: 12/063,133

(22) PCT Filed: Aug. 8, 2006
(86) PCT No.: PCT/GB2006/002969

§ 371 Date: Jun. 15, 2010

(30) Foreign Application Priority Data
Aug. 10, 2005 (GB) 0516457.9

(51) Int. Cl. G06F 1/00

(52) U.S. Cl. 713/300

(57) ABSTRACT

A computing device which if in the process of powering down either to total shutdown or to a standby mode to have this process interrupted by a user request or an external event, in which case the device is able to reverse the power down process and resume full operation, thus improving the user to power dorm experience.

This invention relates to a method of operating a computing device, and in particular to a method of operating such a device which enables the user of the computing device to halt and reverse the process of powering down.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of device already mentioned, together with many other industrial and domestic electronic appliances.

Such devices increasingly include a software controlled power down sequence, during which various items of user and system data are saved from volatile to permanent storage and open communications channels are closed. It should be noted, however, that for certain types of devices this is not always the case. For example, less complex devices which store no user data or have no communications ability can afford an immediate power-off, and there is a minority of devices which are always maintained in a power-on condition and have no means of powering down at all. However, an increasing number of devices do have a relatively lengthy software-controlled power down sequence. These include laptop and desktop computers and mobile phones. It is generally acknowledged that, as computing devices converge, this trend will continue.

As well as software controlled power down sequences, many computing devices also include power on sequences. Both of these sequences can be relatively lengthy. In the case of computer systems running complex operating systems such as Windows and Linux, the length of both the power up and power down sequences can often be measured in minutes; in the case of mobile telephones, tens of seconds are not uncommon.

The length of these sequences can often be perceived as extended and unacceptable delays to a user. This is almost always true of power on sequences; after all, the purpose of powering on a device is to use it in some way, and the longer the power on sequence lasts, the longer a user has to wait before the anticipated actual use can commence. This is also often true of power down sequences because many users frequently have good reasons to wait to see that their device has shut down safely and securely. Hence, extended power down sequences can also be irritating to a user.

There are many cases when the delays are frustrating; this is especially so in circumstances where the delays become cumulative. Consider the case of a user who has finished their work, and tells their computer to power down and switch off, only to realise immediately after the shutdown sequence has been instructed and commenced that they have forgotten to send an email. In this circumstance the user has to wait for the computer to power down and switch off and then the user has to switch the device back on and wait for the power up sequence to finish. This can easily take five minutes or more on a personal computer.

A comparable case is the person who has just pressed the power off button on their mobile telephone when they realise that they have forgotten to make an important call; or perhaps they wanted to make a call in a hurry, didn't realise the telephone was on, and so switched it off by mistake. They too have to wait for both the power down and power up cycles to complete before the required call can be made. This can take in the region of about one minute on some advanced telephones. Though this is less time that it takes for the same operation on a personal computer but the telephone is typically used in more constrained circumstances, so the frustration of the user is unlikely to be any the less.

According to a first aspect of the present invention there is provided a computing device operable to reverse a power down transition sequence that has been initiated, and return to a fully operational state.

According to a second aspect of the present invention there is provided a method of operating a computing device whereby it is enabled to reverse a power down transition sequence that has been initiated, and return to a fully operational state.

According to a third aspect of the present invention there is provided an operating system for causing a computing device according to the first aspect to operate in accordance with a method of the second aspect

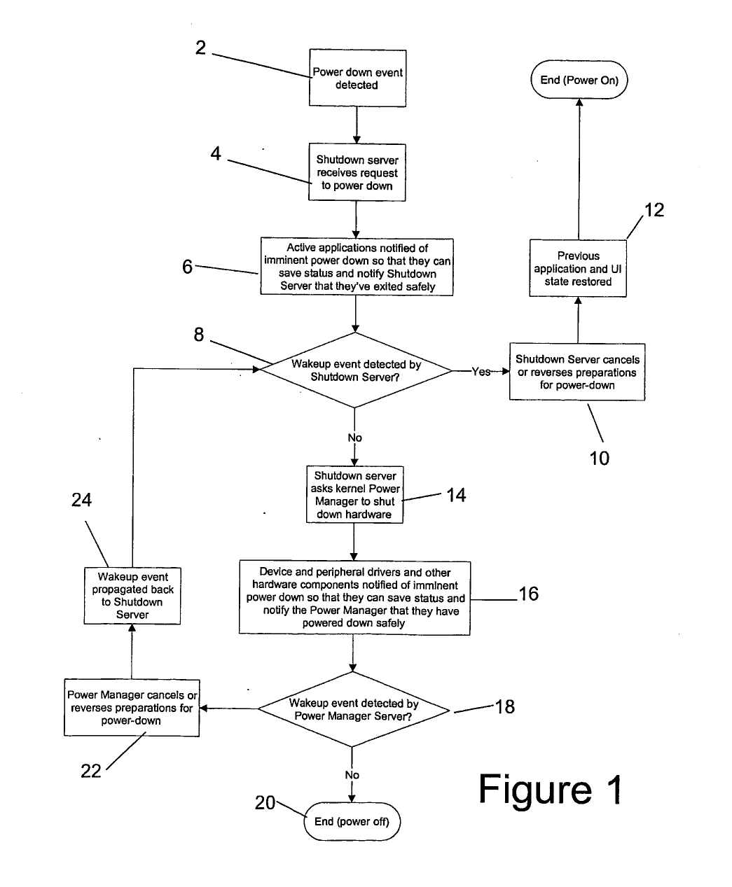

Embodiments of the present invention will now be described, by way of further example only, with reference to FIG. 1 which shows a sequence for effecting or reversing a reversible power transition in a computing device.

The present invention is predicated on the basis that it is desirable for a computing device to have the ability to reverse out of a power down sequence after it has been initiated and then go back to a fully operational state. The same ability can also reverse comparable sequences such as those for standby or hibernation states.

The reversal process can be initiated either by the user or by an event elsewhere on the system; for example, a mobile phone detecting an incoming call when it is in the process of powering off could reasonably decide by itself to reverse the power off process so that the owner can have the opportunity to answer the phone.

The preferred implementation of this invention is for the computing device to be equipped with an operating system (OS) incorporating an integrated power management framework. This framework has at its core a power manager, which provides an application programming interface (API) which can be used to communicate between ordinary user-side or user-mode application programmes and the functional elements of the power manager, which itself runs in supervisor or kernel mode within the operating system. These functional elements include the co-ordinated transition of the central processing unit (CPU), peripherals and hardware platform between various system-wide power states, such as power-on, standby, idle and power-off. They provide the interface to the remainder of the OS kernel which is responsible for controlling the hardware and user software on the device.

The preferred implementation relies on a user-side component to initiate the transitions to standby and off states. Preferably, there should only be one such component in the system. This component is referred to in the context of this invention as the shutdown server.

The framework provides support for wakeup events. These are hardware events specific to each low power state, which, if they occur during a system-wide power transition, may result in the transition being cancelled or even reverted, as can be seen from FIG. 1. If they occur during standby, they may trigger a return to the active state. Wakeup events for the standby or off states usually relate to user interactions or timed sources. The kernel-side power manager provides support for tracking these events and notifying the user-side shutdown server of their occurrence.

The shutting down of the phone is typically triggered by the user pressing a power button. In other cases, defined by a UI policy, it may be triggered by a user inactivity timer. These events are detected at kernel level and propagated to the shutdown server. This starts the power transition by notifying active applications that a transition is imminent, allowing the applications to save status and shut down. It is only after all this is done that the shutdown server requests the kernel framework to transition the CPU, peripherals and the hardware platform to the required target state, in this example a power-off state.

The reverse applies to the transition from standby to active, with the CPU and peripherals transitioning first, and then a notification generated at the kernel framework level being propagated upwards to the shutdown server which is responsible for transitioning the rest of the system.

A key perception of this invention is therefore that transitions to standby and off states are not instantaneous. From the moment the user requests the shutting down of the computing device, until the power manager is requested to perform the transition at kernel level there is typically a lengthy preparation phase in which UI state and application data are saved, and applications are shut down. This invention provides therefore, as part of its operation, wakeup events that are detected kernel-side to be communicated to the shutdown server during the preparation phase, as shown in FIG. 1.

On receiving a wakeup event, the shutdown server can cancel or reverse its own preparations for the system-wide transition as necessary, thereby restoring the previous state of UI and applications.

Wakeup events are hardware-specific, and the kernel-level part of the power framework maps a set of events to each target low power state. The shutdown server is able to set a target low power state for a system-wide transition and enable the wakeup events for that state. It is also able to request notification of their occurrence, and in time, request the kernel framework to transition to that state.

When deciding to stop or reverse the preparations to a system-wide transition to a low power state, the shutdown server is arranged so that it is able to request the disabling of wakeup events for that low power state, and the setting of the power state to active. It is also able to cancel the request for notification of other wakeup events.

It should be noted that once control has been passed to the kernel-side power manager, and once it has initiated a transition to off or standby, the shutdown server cannot on its own issue a command to stop that transition.

All of the user-side requests are routed to the power manager, which manages all the kernel-side power transitions. It receives requests to power off or assume a standby state from the shutdown server, and dispatches relevant notifications of the request to the components that manage the power transition of the peripherals and the CPU. All registered peripheral drivers are noted of an imminent power down through a power handler associated with each peripheral. Upon receiving these notifications, peripheral drivers change the power state of the peripheral they control so as not to compromise the eventual system-wide power transition that is taking place. As peripheral power down may take some time, each power handler owns a fast semaphore, which the power manager waits on, after requesting it to power down the peripheral. This semaphore is signaled upon completion of the respective peripheral power down.

Finally, after all peripherals have powered down, the power manager requests the CPU's power controller to power down the CPU.

If the target state of the system-wide power transition is off, instruction execution terminates soon after the call to the CPU power controller is issued. If the target state is standby, the CPU is eventually brought back to the active state when a wakeup event occurs. Instruction execution is resumed with the CPU inside the power controller call, and then control is returned to the power manager, which then powers up all peripheral drivers owning a registered power handler, and waits for these drivers to power up, in a sequence that is the reverse of the power down explained previously.

Wakeup events may also occur during the user-side transition, and if they are enabled, are propagated up to the component that initiated that transition. Wakeup events are monitored at the variant-specific level, so every request to enable or disable them is propagated down to the power controller.

Each system-wide low power state (such as standby and off) may have a different set of wakeup events. So, if the shutdown server requests the enabling of wakeup events when the target state is already a low power state, the power manager disables the set of events corresponding to the previous low power state before enabling the set of events corresponding to the new low power state. If the shutdown server requests the disabling of wakeup events, the power manager assumes that it has decided to stop or reverse the transition, so it is sets the target state to active.

The power controller may monitor wakeup events directly, or delegate this to a peripheral driver. In the latter case, the peripheral driver notifies the power controller of the occurrence of a wakeup event, and the power controller then propagates the notification to the power manager, which completes any pending user-side request for notification.

If the target low power state of a system-wide transition is standby, and a wakeup event happens after the kernel framework is requested to transition, but before the CPU is moved to that state, then the implementation does not complete the transition. If no event occurs, it will return when a detected wakeup event finally occurs.

The process for a reversible power transition will now be described with reference to FIG. 1.

At step 2 the power down event is detected and the shutdown server receives a request to power down, as shown as step 4 in FIG. 2. In response, the active applications are notified of imminent power down of the device so that they can save status and notify the shutdown server that they have exited safely. This can be seen from step 6 in FIG. 2. If a wakeup event has been detected by the shutdown server, such as may arise from the user canceling the shutdown request, the shutdown server cancels or reverses the preparations made for power down, and the previous application and UI states are restored. This is shown as steps 8 to 12 in FIG. 1.

However, if a wakeup event is not detected by the shutdown server, the shutdown server requests the kernel power manager to shut down all the hardware. The device and peripheral drivers, and other device hardware components, are notified of the imminent power down so that they can save status and notify the power manager that they have powered down safely. If no subsequent wakeup event is detected by the power manager server, the device is powered off. This is shown as steps 14 to 20 in FIG. 1.

If a wakeup event is detected by the power manager server, the power manager cancels or reverses the preparations for power down, and the wakeup event is propagated back to the shutdown server, as can be seen by steps 22 and 24 of FIG. 1.

It can be seen therefore that this invention enables a user to avoid the necessity for a device to undergo a full power down sequence followed by a full power up sequence. Hence, this invention makes both the user and, more particularly, the device more efficient in operation and also provides a superior user experience.

The invention provides, therefore, a computing device which if in the process of powering down either to total shutdown or to a standby mode to have this process interrupted by a user request or an external event, in which case the device is able to reverse the power down process and resume full operation, thus improving the user experience.

Although the present invention has been described with reference to particular embodiments, it will be appreciated that modifications may be effected whilst remaining within the scope of the present invention as defined by the appended claims.

1. A computing device operable to reverse a power down transition sequence that has been initiated, and return to a fully operational state.

2. A device according to claim 1 wherein the power down transition sequence is initiated either by a user of the device or in response to an external event.

3. A device according to claim 1 or claim 2 operable to have power down transition sequences initiated and prepared for by a user mode component and to be carried out by a kernel mode component.

4. A device according to claim 3 wherein the kernel mode component is enabled to either track the occurrence one or more wakeup events or request notification from another delegated kernel mode component that a wakeup event has occurred, and wherein the said kernel mode component is operable to notify the user mode component when a wakeup event occurs.

5. A device according to claim 4 wherein the user mode component is operable to cancel, in response to a notification of the occurrence of a wakeup event, requests for the notification of another wakeup event, to reverse preparations made or initiated for a power down transition sequence, and to cancel preparations not commenced.

6. A device according to any one of claims 3 to 5 comprising registered peripheral drivers for powering down peripherals attached to the device using the power down transition sequences in response to a request from the kernel mode component.

7. A device according to claim 7 wherein the kernel mode component is operable to wait on a respective semaphore for each peripheral to be powered down.

8. A device according to any one of the preceding claims operable to assume a standby or hibernation low-power mode, or a power off mode in response to the power down transition sequence.

9. A method of operating a computing device whereby it is enabled to reverse a power down transition sequence that has been initiated, and return to a fully operational state.

10. A method according to claim 9 in which the power down transition sequence is initiated either by a user of the device or in response to an external event.

11. A method according to claim 9 or 10 wherein power down transition sequences are initiated and prepared for by a user mode component and are carried out by a kernel mode component.

12. A method according to claim 11 in which the kernel mode component is enabled to either track the occurrence one or more wakeup events or request notification from other delegated kernel mode components that wakeup events have occurred and in which the kernel mode component notified the user mode component when a wakeup event occurs.

13. A method according to claim 12 in which the user mode component that is preparing for or has initiated a power down transition sequence receives a notification of the occurrence of a wakeup event which causes it to cancel requests for the notification of other wakeup event, and reverse and undo all the preparations it has made and cancel any it has not made.

14. A method according to any one of claims 11, 12 or 13 in which powering down of peripherals attached to the device is undertaken by registered peripheral drivers at the request of the kernel mode component.

15. A method according to claim 14 in which the kernel mode component waits on a respective semaphore for each of the peripherals to be powered down.

16. A method according to any one of claims 9 to 15 in which the power down transition sequence is arranged to cause the device to switched off or to assume a standby or hibernate low-power mode.

17. An operating system for causing a computing device to operate in accordance with a method as claimed in any one of claims 9 to 16.
